(19) United States
(12) Patent Application Publication
(10) Pub. No.: US 2003/0074212 A1
(43) Pub. Date: Apr. 17, 2003

(54) Online enterprise diagnosis system and method

(75) Inventor: Wang Yu Lun, Taipei (TW)

Correspondence Address: BACON & THOMAS, PLLC, 625 SLATERS LANE, FOURTH FLOOR, ALEXANDRIA, VA, 22314

(73) Assignee: Easy 221 Consulting Inc., Taipei (TW)

(21) Appl. No.: 10/026,971

(22) Filed: Dec. 27, 2001

(30) Foreign Application Priority Data
Oct. 12, 2001 (TW) 090125264

(51) Int. Cl. G06F 17/60

(52) U.S. Cl. 705/1; 705/35

(57) ABSTRACT

This specification discloses a system and method that are used in an environment of network transmissions to set up a professional consulting website. Through real-time interactions with a user via a network, the user can enter financial data of the enterprise for the past few years. An industrial database is further used to compare the competitive power and kernel potential of the company with other companies in the same industry. This disclosed system can provide an enterprise a management diagnosis report in the format of web page tables in real time so that the enterprise owner can immediately learn of the financial diagnosis opinions, while at the same time maintain the privacy of commercial secrets.

### BACKGROUND OF THE INVENTION

1. Field of Invention

The invention relates to an online enterprise diagnosis system and method. More particularly, the invention relates to a system and method that are used in an environment of network transmissions to have real-time interactions with a user through the network so that the user can enter data in a web page table and obtain a real-time analysis report for enterprise management generated by a program and database designed by business consultants.

2. Related Art

In an era of knowledge-based economy, most medium and small enterprises often cannot understand the concept of a knowledge economy and cannot build a knowledge economy system due to deficiencies in manpower and capital. Managers of traditional medium and small enterprises thus must resort to external help. They often hire professional consultants to make suggestions and advise the business in order to broaden its perspective by relying on the knowledge and experience of the professional consultants. The consultants perform a thorough diagnosis of the enterprise to make improved investment policies.

However, for a very few elite consultants the biggest problem is the time limitation. It is very hard to satisfy the demands from millions of medium and small enterprises. If these elite consultants are hired by several companies, they often cannot maintain required quality and may even violate their agreements by carelessly releasing commercial secrets.

Medium and small enterprises or start-up businesses are usually unable to get good financial managers or professional consultants due to limited resources. In fact, many enterprises go bankrupt simply because of inappropriate finance planning, resulting in ineffective resource and capital use, not just because of bad market conditions or lack of technical breakthrough. Such errors in finance policies result from incorrect decisions by the business managers. Very often, they have not done careful financial analysis. Thus, getting an experienced consultant to help run the business is necessary. Nevertheless, a good professional consultant is hard to find. Therefore, it would be highly desirable to provide a real-time online enterprise management diagnosis system so that enterprise administrators can obtain appropriate advice at all times.

With reference to FIG. 1, the consulting interactions between a conventional business director 1 and a professional consultant are mainly based upon the analyses of the data exchanged during verbal and document communications. The analyses performed by the consultant mostly rely on the experiences he or she has had in the past. They often do not employ actual industrial data as the standards or bases for the analyses. When an enterprise owner wants to perform such analyses as industrial activities and depressions, assets liabilities, balance sheets, and finance distributions, a lot of enterprise financial documentation 3 have to be given to the consultant 2. Sometimes due to misunderstandings during communications, the data provided by the enterprise owner is incomplete or incorrect. Thus, the enterprise owner 1 has to supplement with related documents 5. After receiving such a large amount of data, the consultant has to spend a quest deal of time in organizing, analyzing and computing before a data analysis can be performed based upon the consultant's experience. Finally, the analysis results are put into a report to be given to the owner 1. Furthermore, during the analysis process, both parties have to go through bi-directional communications on the issues of data to be provided by the enterprise owner 1 and the analysis directions. This process forces the consultant 2 to maintain continuous communications with the enterprise owner 1, making the whole analysis tedious and time-consuming. At the end, the report may not be appropriate by the time it is finished. Finally, in the process of sending enterprise analysis data to the consultant 2, it is highly possible to release commercial secrets due to human errors and data losses.

### SUMMARY OF THE INVENTION

Accordingly, an objective of the invention is to provide a system and method that are used in an environment of network transmissions to have real-time interactions with a user through the network so that the user can enter financial data of the enterprise for the past few years according to the problems posted on the website and obtain a real-time analysis report for enterprise management.

Another objective of the invention is to provide an industrial database so that at the same time the user enters the past financial data of the enterprise, the diagnosis report can be contrasted with the power and abilities of other competitive companies. The comparison results are analyzed so that the finance distribution of the enterprise can be allocated optimally.

A further objective of the invention is to allow the user to anonymously enter the past financial data of the enterprise according to the problems posted on the web without facing the consultant. It also allows the user to modify entered data at any time. This function can achieve the goal of protecting commercial secrets.

In the prior art, the enterprise owner and the consultant often have to make repeated communications and data supplements due to misunderstandings during the consultation process. This not only increases the time for data preparation and analysis, but also affects the efficiency and secret of the analysis results.

The invention provides a system and method that are used in an environment of network transmissions to have real-time interactions with a user through the network so that the user can enter data in a web page table and obtain a real-time analysis report for enterprise management generated by a program and database designed by business consultants. Therefore, the enterprise diagnosis report obtained by the enterprise satisfies the real-time and confidential requirements, effectively increasing the competitive power of the company.

### BRIEF DESCRIPTION OF THE DRAWINGS

The present invention will become more fully understood from the detailed description given herein below, such description being by way of illustration only and thus is not limitative of the present invention, wherein:

FIG. 1 is a schematic view of consulting interactions between an enterprise owner and a professional consultant;

FIG. 2 shows an environmental structure of the disclosed online enterprise diagnosis system;

FIG. 3 is a structural diagram of the data input table in FIG. 2;

FIG. 4 is a flowchart of the disclosed online enterprise diagnosis method;

FIG. 5 shows one diagnosis report output web page table of the disclosed system and method; and

FIG. 6 shows another diagnosis report output web page table of the disclosed system and method.

### DETAILED DESCRIPTION OF THE INVENTION

The online enterprise diagnosis system and method are mainly used in an environment of network transmission technologies. In accordance with the real-time requirements for different industrial diagnosis evaluations, the invention utilizes a medium-to-large network server or cluster system to save time in repeated analyses and consultations, while simultaneously increasing the speed and privacy of the enterprise diagnosis services.

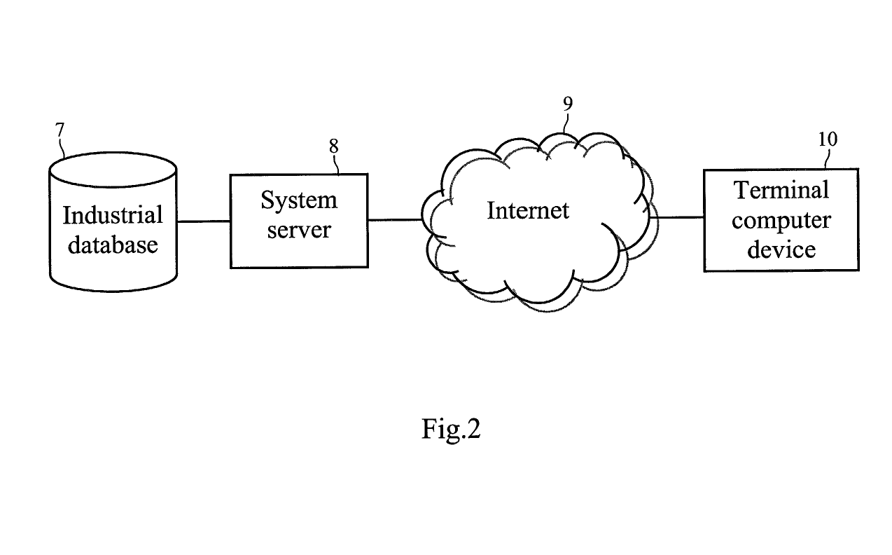

With reference to FIG. 2, the online enterprise diagnosis system is used in an environment with network transmissions to provide web page contents needed by a terminal computer device 10. The online enterprise diagnosis system includes: an industrial database 7 and a system server 8, where the industrial database 7 stores financial evaluation data and development data of all industries. When the user of the terminal computer device 10 connects to the system server 8 through the Internet 9, the system server 8 provides a web page table with a series of Q&A interactions to the terminal computer device 10. The contents of the web page table include a plurality of financial item problems and the corresponding input fields for the user to enter data. The data include text data and digital data. Once the user fills all the data asked by the system server 8 via the terminal computer device 10, the user also sends out a message from the web page table confirming the diagnosis request to the system server 8. Normally, this diagnosis request is sent out by depressing a button on the web page table.

After the system server 8 receives the requests sent out from the terminal computer device 10, it immediately performs diagnostic processing procedures. The entered financial data along with the digital data in the above-mentioned input field are computed together to obtain diagnosis results according to predetermined formulae. Such diagnosis data are compared with the corresponding evaluation data in the industrial database 7, obtaining the difference in between for further analysis. Finally, the opinions and suggestions are integrated into a diagnosis report in web page format, which is then transmitted to the terminal computer device 10 through the Internet. In this embodiment, the network transmission structure can speed up the transmissions of data analyses and diagnosis reports. The user can make a real-time online enterprise diagnosis for different industries. The diagnostic processing procedure performed by the system server 8 can be achieved using a programming language.

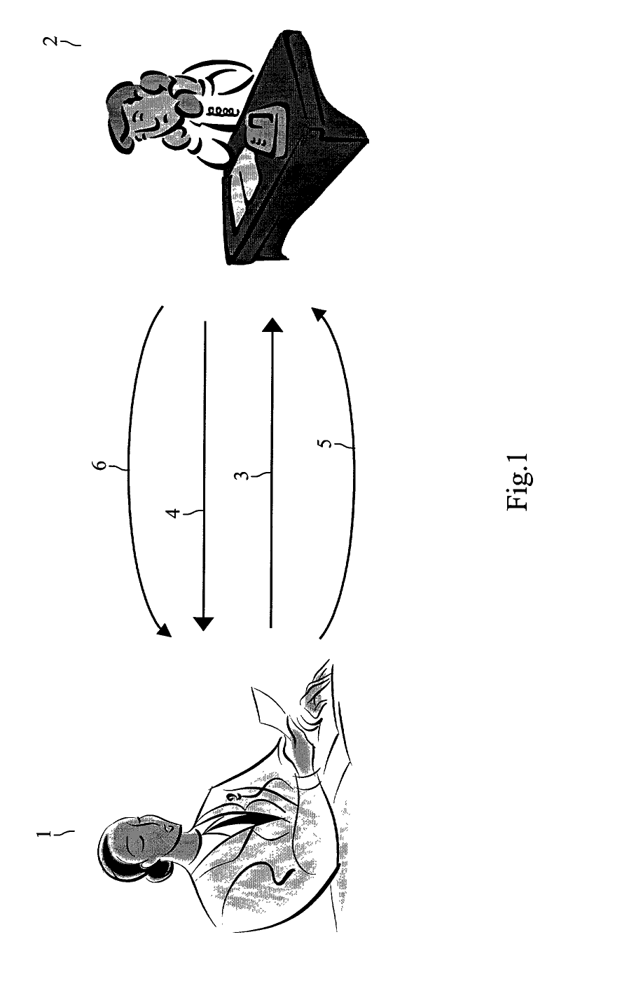

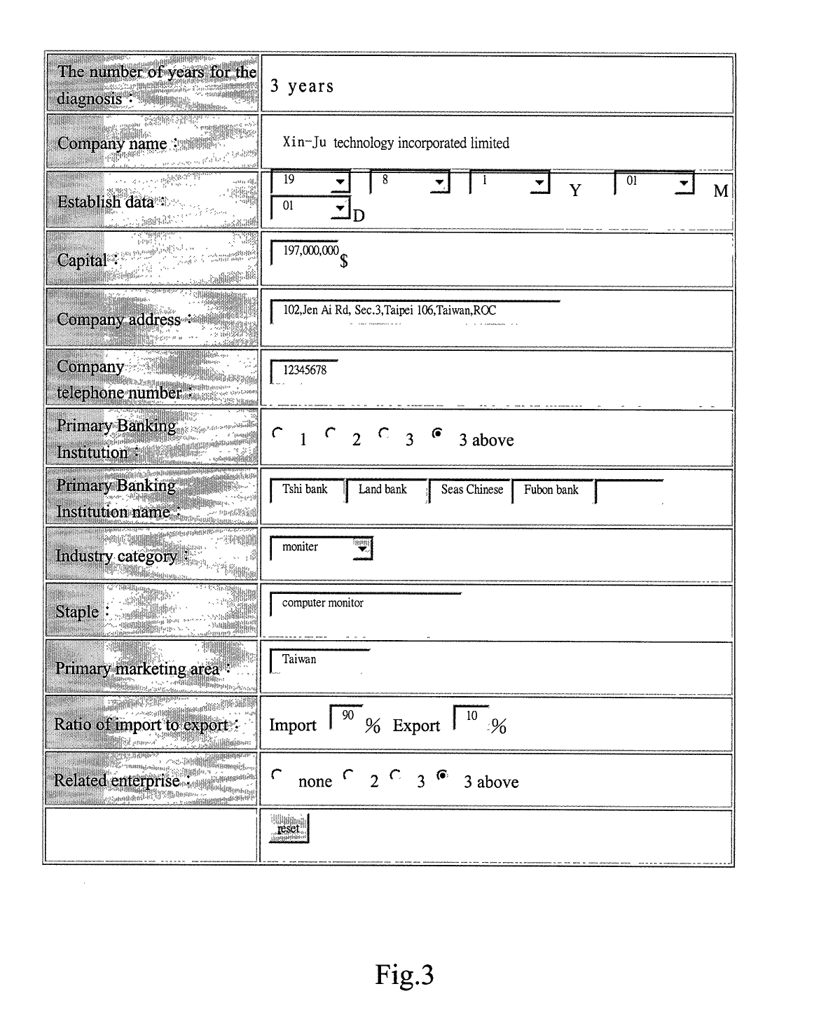

With reference to FIG. 3 and FIG. 1, the disclosed online diagnosis system and method use interactive network interfaces to generate a series of web page tables for users to enter data. Through the program and database carefully designed by consultants, the web page tables include a plurality of questions and the corresponding input fields. In an embodiment of the invention, users enter or select enterprise financial data and selections according to the questions in the tables. Such data and selections cover company basic data, capital, industrial category, ratio of import and export, and related enterprises. This allows users to clearly understand exactly what data are needed for the type of diagnosis.

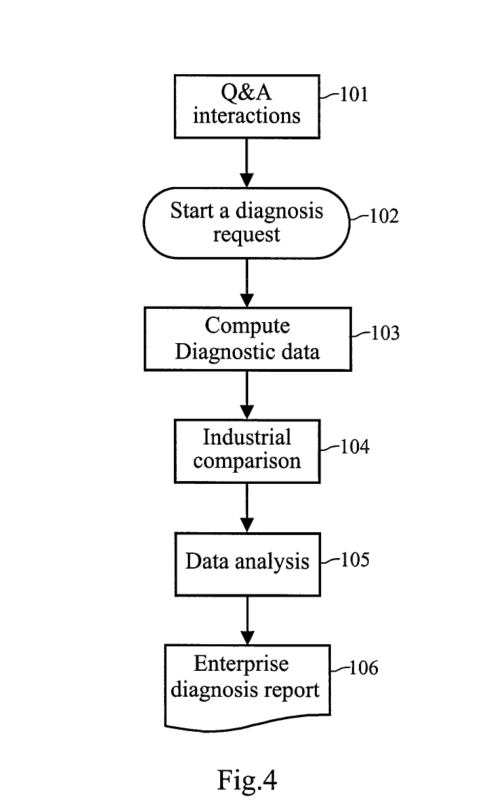

With reference to FIG. 4 and FIGS. 1, 2 and 3 again, the disclosed method includes the following procedures:

Procedure 101: Q&A Interactions

When a user wants to perform a diagnostic analysis on the management of his or her business, the user has to enter the number of years for the diagnosis, a text description of basic information and numbers of past financial data, pointing out a definite direction to do the analysis. He or she only needs to follow the hints on the web page to fill out all fields in the table. The user also makes sure that the entered data are correct before going onto the next page. If there is any mistake or typographical error, the user can go back to the previous page at any time to make corrections. This solves the problem of analysis time delay due to incorrect data provision. In particular, the data provided by the user in the web page table include text and digital data.

Procedure 102: Start a Diagnosis Request

When a user correctly enters financial data of the enterprise in the past and completes procedure 101, the user can press a button on the web page table to send the diagnosis request. This diagnosis request message is then sent to the system server 8 to perform a diagnostic processing procedure.

Procedure 103: Compute Diagnostic Data

After obtaining the text and digital data entered by the user in the Q&A interactive web page tables, the system server 8 computes the diagnostic data for the company according to predetermined financial rate formulae and the data entered in procedure 101. That is, the diagnosis data for the enterprise are calculated according to the financial data of the past few years entered by the user. The diagnosis data include various kinds of financial data such as guaranteed interest rate, profit capabilities, gross profits, sales profits, and growth power.

Procedure 104: Industrial Comparison

After the user enters the financial data of the company for the past few years in procedures 101, 102 and obtains such diagnosis data as guaranteed interest rate, profit capabilities, gross profits, sales profits, and growth power, the system will refer to data stored in an industrial database to make a comparison. Since this database stores reference financial data of all industries, it is used as a standard to compare with the financial data provided by the user. The diagnosis data in procedure 103 are compared with the data of companies in the same industry as recorded in the industrial database 7, finding out the difference in between. In an embodiment of the invention, the user enters a liquid asset of $1.8 million and a liquid debt of $1 million. Thus, the liquid ratio is computed to be 180%, in comparison with the averaged 120%, say, in the same industry. One thus sees a 60% difference between this company and other companies of the same type. This is then used to determine whether the company is running well or not.

Procedure 105: Data Analysis

When the system obtains all needed financial data, diagnosis data and comparison with other companies in the same industry in procedures 101, 102, 103 and 104, the differences given in procedure 104 are used to find out the corresponding opinions from a difference correspondence table. For example, the liquid ratio of the user's enterprise is higher than the average liquid ratio in the same industry by 60%. The liquid ratio (liquid assets/liquid debt) is used to determine the ability that the enterprise can pay debt within a short term. It turns out that the opinion says “Good”. The finance distribution or other items including the ratio of debt to capital (total debt/total asset) indicate the ratio of intervening capital in the capital resources. The bigger the ratio is, the more debts the company has. If the ratio of the long-term capital to fixed capital ((stock holder profits+long term debts)/fixed assets) is over 100, it shows that the investment of fixed assets is all from long-term capital and some of the long-term capital is borrowed for short-term operations. If it is smaller than 100, then the company's capital is improperly managed. Once banks become stringent, there might be serious financial problems for the company. Since the financial data being analyzed are past financial data, the results are definite and the system 8 runs a program to find out the corresponding descriptions. Using the industrial database 7 made by a program rather than personal experience will be more objective.

Procedure 106: Enterprise Diagnosis Report

After completing data calculations, determinations and analysis in procedures 101, 102, 103, 104 and 105, the system server 8 collects the results from each procedure into an enterprise diagnosis report and presents it in web page format on the terminal computer device 10. The web page table contents of the enterprise diagnosis report include: the text data entered by the user during the Q&A interactions in procedure 101 (such as text description of the company's basic information), the diagnostic financial data in procedure 103, and the analysis result from comparing data difference and advice (such as industrial growth analysis, industrial trend, and text description and statistical data of financial analysis) provided by the industrial database in procedure 105. Finally, the enterprise diagnosis report provides an overall diagnostic advice and conclusions according to the analysis results. These diagnostic advice and conclusions are stored in the industrial database 7 in advance. Through the analysis in procedures 103, 104 and 105, the industrial database 7 extracts the analysis advice. Such advice includes opinions of the financial structure, debt-paying ability, profits conditions, management strategies and growth power of the company so that the user can clearly understand how well the company runs from the report, thereby adjusting and improving its finance.

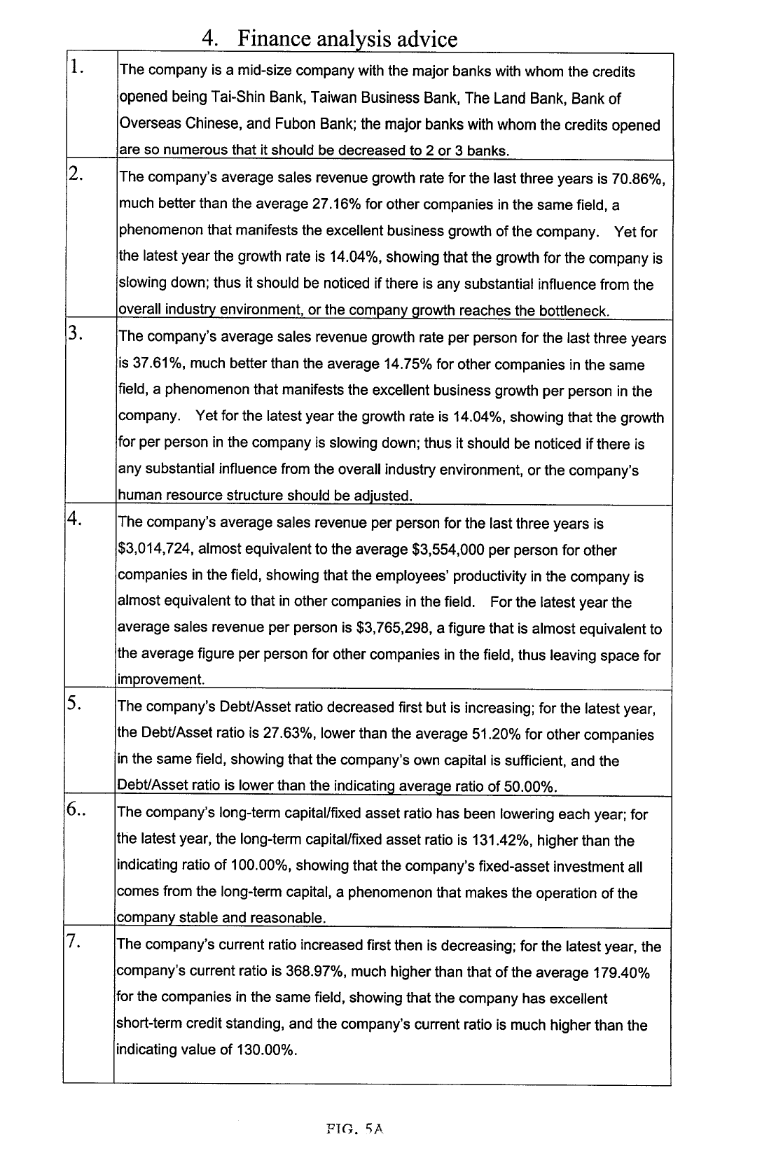

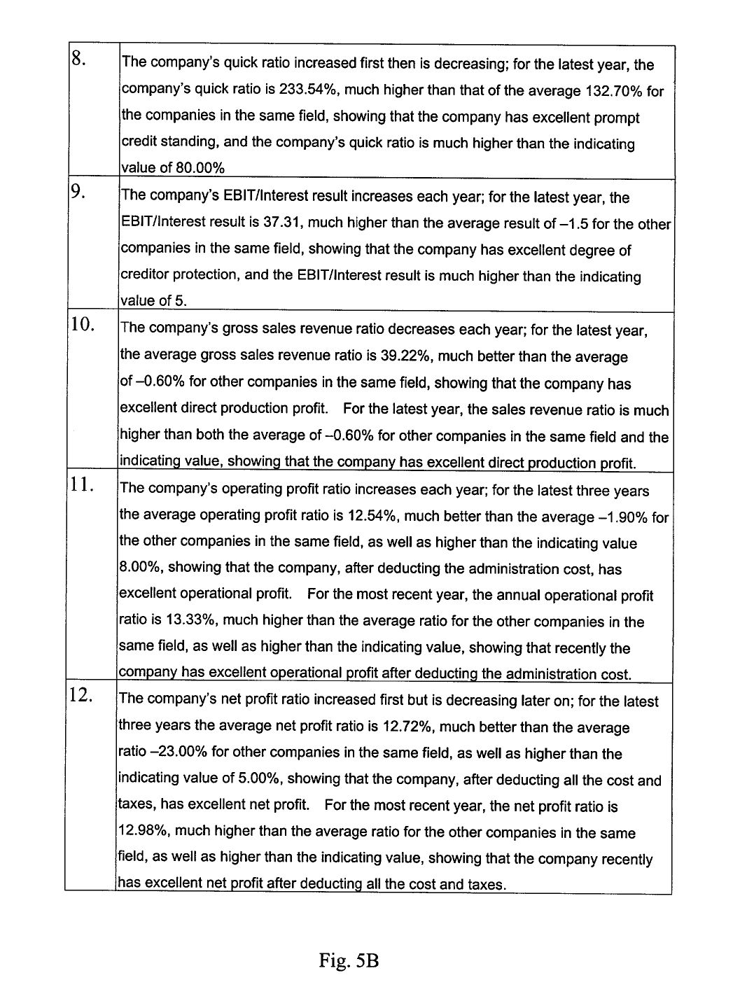

With simultaneous reference to FIGS. 5 and 4. In this embodiment, when a user completes a series of web page Q&A input a diagnosis request message is sent out. The system server 8 collects the text description of the company's basic information and its financial data entered by the user into an enterprise diagnosis report according to the analysis results. This report is presented the form of web page tables. It shows basic information, industrial growth analysis, an asset liabilities table, a profit and loss table, finance distribution analysis, balance analysis and finance analysis advice for the analyzed data. The finance analysis advice includes digital data coming from procedure 103 or 104. Part of the text data comes from the analysis opinion in procedure 105.

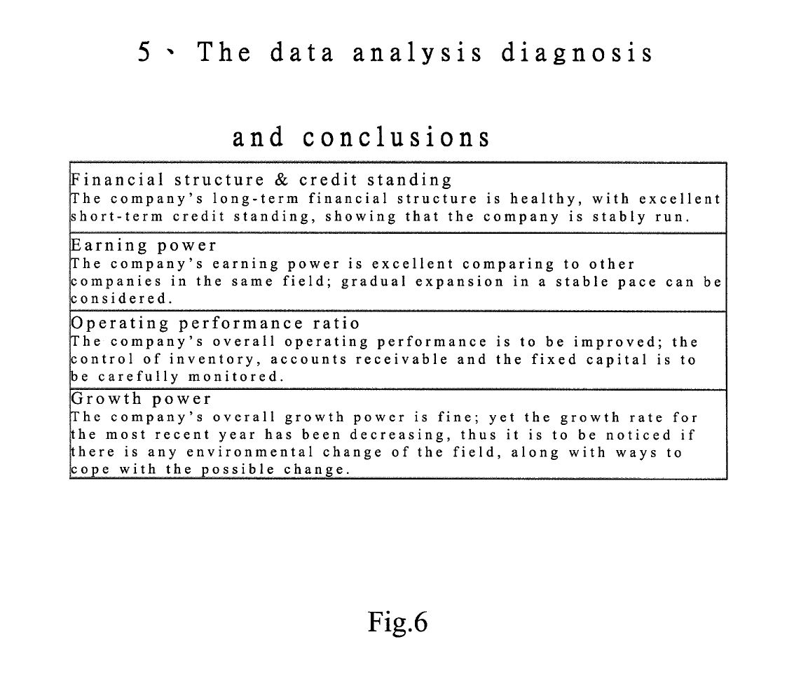

As shown in FIGS. 4, 5, and 6, after the data analysis overall diagnosis advice and conclusions are given to the company according to the results along with data provided in the industrial database. Such advice includes opinions of the financial structure, debt-paying ability, profits conditions, management strategies and growth power of the company so that the user can clearly understand how well the company runs from the report, thereby adjusting and improving its finance.

### Effects of the Invention

The disclosed online enterprise diagnosis system and method have many advantages and features. The method can be used to set up a professional online consulting website in a network transmission environment. Through the real-time interactions, a user can enter financial data of the enterprise for the past few years according to the questions provided by the website in order to save time for enterprise management diagnosis.

Another advantage of the invention is that under the network transmission environment, an industrial database is used to compare analysis results of the enterprise with other companies in the same industry. Therefore, the comparison results will be more accurate than conventional methods. The company can make an optimal adjustment to its finance distribution.

A further advantage of the invention is that it allows users to enter data anonymously without meeting with the consultants. The user can make partial adjustments to the entered data at any time. Therefore, the invention can guarantee the security of commercial secrets.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An online diagnosis method used in a network transmission environment, which method comprises the steps of:
generating a series of web page tables, whose contents include a plurality of questions and the corresponding input fields;
computing diagnostic data for finance items according to predetermined formulae and the data entered in the plurality of fields;
comparing the diagnostic data for finance items with data stored in an industrial database to obtain differences between them;
obtaining analysis opinions from the differences according to a difference correspondence table; and
producing a diagnosis report in web page format that includes the analysis opinions at least.

2. The method of claim 1, wherein the data entered in the plurality of fields include text data and digital data.

3. The method of claim 1, wherein the diagnostic data include guaranteed interest rate, profit capabilities, gross profits, sales profits, and growth power.

4. The method of claim 1, wherein the industrial database stores digital reference data of finance items of various industries for comparison.

5. The method of claim 1, wherein the difference correspondence table stores the analysis opinions corresponding to different financial data.

6. The method of claim 1, 2, or 3, wherein the digital data of the diagnosis report include the diagnostic data and differences.

7. The method of claim 4 or 5, wherein the text data in the diagnosis report include text information provided by the industrial database and the difference correspondence table.

8. An online diagnosis system providing a series of web page tables to a terminal computer device through a network transmission environment, which system comprises:
an industrial database storing data of finance items for comparison;
a difference correspondence table storing analysis opinions corresponding to different variations of the finance items; and
a system server providing a plurality of questions and the corresponding input fields on the web page tables and responding to a request from the terminal computer device to start a diagnostic process;
wherein the diagnostic process includes the steps of: computing diagnostic data of finance items according to the data entered in the fields; comparing the diagnostic data with the data of the corresponding finance items in the industrial database to obtain digital differences; obtaining analysis opinions corresponding to the digital differences; presenting a diagnosis report comprising at least the analysis opinions in web page format on the terminal computer device.

9. The system of claim 8, wherein the system server runs a program to execute the diagnosis process.

10. The system of claim 8, wherein the digital data of finance items include guaranteed interest rate, profit capabilities, gross profits, sales profits, and growth power.

11. The system of claim 8, wherein the system server compares the diagnostic data with the corresponding data stored in the industrial database to obtain the digital differences.

12. The system of claim 8, wherein the system server obtains the analysis opinions corresponding to the digital differences according to the difference correspondence table.

13. The system of claim 8, wherein the digital data of the diagnosis report presented in web page format by the system server include the diagnostic data and the digital differences.

14. The system of claim 8, wherein the text data of the diagnosis report presented in web page format by the system server include the text data provided by the industrial database and the difference correspondence table.

15. An online diagnosis method used in a network transmission environment so that after a user enters data answering questions on a series of web page tables a diagnosis request message is sent out to execute the online diagnosis method, wherein the method comprises the steps of:
computing diagnostic data for finance items according to predetermined formulae and the entered data;
comparing the diagnostic data for finance items with data stored in an industrial database to obtain differences in between;
obtaining analysis opinions from the differences according to a difference correspondence table; and
producing a diagnosis report in web page format that includes the analysis opinions at least.

16. The method of claim 15, wherein the digital data of finance items include guaranteed interest rate, profit capabilities, gross profits, sales profits, and growth power.

17. The method of claim 15, wherein the entered data include text data and digital data.

18. The method of claim 15 or 16, wherein the digital data in the diagnosis report include the diagnostic data and the differences.

19. The method of claim 15, wherein the text data in the diagnosis report include text information provided by the industrial database and the difference correspondence table.
